(19) United States
(12) Patent Application Publication
(10) Pub. No.: US 2013/0342178 A1
(43) Pub. Date: Dec. 26, 2013

(54) POWER SUPPLY MODE SWITCHING CIRCUIT AND METHOD

(71) Applicant: ASKEY COMPUTER CORP., New Taipei City (TW)

(72) Inventor: Wei-Chung Wang, Keelung City (TW)

(73) Assignee: ASKEY COMPUTER CORP., New Taipei City (TW)

(21) Appl. No.: 13/672,831

(22) Filed: Nov. 9, 2012

(30) Foreign Application Priority Data
Jun. 22, 2012 (TW) 101122396

(51) Int. Cl. G05F 1/66

(52) U.S. Cl. CPC G05F 1/66
USPC 323/234

(57) ABSTRACT

A power supply mode switching circuit and method switch between power supply modes of a power supply device dynamically based on an operating current required for operation of an electronic product, such that the power supply device supplies a supplying current corresponding to the operating current. The circuit comprises a sampling unit, an amplifying unit, a comparing unit. The circuit is disposed between the power supply device and the electronic product, samples the supplying current from the power supply device with the sampling unit, and converts the supplying current into a sampling voltage. The amplifying unit converts the sampling voltage into an amplifying voltage by voltage amplification and outputs the amplifying voltage to the comparing unit. After comparing the voltage level of a reference voltage and that of the amplifying voltage, the comparing unit generates a control signal for switching the power supple modes of the power supply device.

### CROSS-REFERENCE TO RELATED APPLICATION

This non-provisional application claims priority under 35 U.S.C. §119(a) on Patent Application No(s). 101122396 filed in Taiwan, R.O.C. on Jun. 22, 2012, the entire contents of which are hereby incorporated by reference.

### FIELD OF TECHNOLOGY

The present invention relates to switching circuit and method, and more particularly, to a power supply mode switching circuit and method for switching between power supply modes of a power supply device dynamically based on an operating current required for an electronic product in operation, so as to output a supplying current matching the operating current.

### BACKGROUND

According to the prior art, a power supplying device has a plurality of power supply modes and chooses in advance one of the power supply modes in accordance with the total circuit load of an electronic product to attain the optimal power conversion efficiency whenever the power supplying device supplies power to the electronic product. The power conversion efficiency is defined as the ratio of output power to input power. In general, the power conversion efficiency is denoted with η. A high η value indicates high power conversion efficiency.

However, it is not uncommon for the electronic product in operation to have different operating current requirements. If the power supplying device keeps operating in a specific power supply mode, its power conversion efficiency cannot be optimal all the time, that is to say, chances are the power supplying device supplies more power to the electronic product than what is actually required for the electronic product, thereby causing a waste of resources.

In attempt to overcome the aforesaid drawback, the prior art provides two methods for switching between the power supply modes with a view to maintaining a high power conversion efficiency. One of the methods involves detecting the operating current of the electronic product with a detection-oriented integrated circuit built in the power supplying device; however, the method is flawed with disadvantages, namely the detection-oriented integrated circuit is expensive, fails to accommodate itself to various electronic products, and thus has to be custom-made. The other method involves switching between the power supply modes by means of a general-purpose I/O (GPIO) pin and software adapted to monitor the operating current of an the electronic product and installed on the electronic product; however, the method has a disadvantage, that is, the software in operation has to be monitored by a software engineer and thus lacks ease of use.

Furthermore, the software-based monitoring method involves an algorithm of software, and thus a monitoring result varies from algorithm to algorithm. As a result, the software-based monitoring method is flawed with inaccuracy.

Accordingly, it is imperative to provide a power supply mode switching circuit and a power supply mode switching method to overcome the aforesaid drawbacks of the prior art.

### SUMMARY

It is an objective of the present invention to provide a power supply mode switching circuit for switching between power supply modes of a power supply device dynamically based on an operating current required for an electronic product in operation, so as to output a supplying current matching the operating current and thereby save power.

Another objective of the present invention is to provide a power supply mode switching method for switching between power supply modes of a power supply device dynamically based on an operating current consumed by an electronic product in operation, so as to output a supplying current matching the operating current.

In order to achieve the above and other objectives, the present invention provides a power supply mode switching circuit for switching between power supply modes of a power supplying device dynamically based on an operating current required for an electronic product in operation, so as to output a supplying current matching the operating current, the power supply mode switching circuit comprising: a sampling unit having a first input end and a first output end, connected to the electronic product and the power supplying device, respectively, and adapted to convert the supplying current from the power supplying device into a sample voltage; an amplifying unit parallel-connected to the sampling unit, having a second input end and a second output end, receiving the sample voltage via the second input end to transform the sample voltage into an amplified voltage by voltage amplification, and outputting the amplified voltage via the second output end; and a comparison unit having a third input end, a third output end, and a reference voltage end, the third input end being connected to the amplifying unit, the reference voltage end receiving a reference voltage, the comparison unit comparing the amplified voltage and the reference voltage and outputting a control signal via the third output end for switching between the power supply modes.

In order to achieve the above and other objectives, the present invention provides a power supply mode switching method for switching between power supply modes of a power supply device dynamically based on an operating current required for an electronic product in operation, so as to output a supplying current matching the operating current, the power supply mode switching method comprising the steps of: sampling the operating current by a sampling unit so as to generate a sample voltage; receiving a reference voltage by a comparison unit so as to allow the comparison unit to perform voltage comparison based on the reference voltage; determining a voltage amplification ratio of the reference voltage to the sample voltage and vice versa and multiplying the sample voltage by the voltage amplification ratio to generate an amplified voltage such that a ratio of the amplified voltage and the reference voltage is less than a predetermined value; comparing the reference voltage and the amplified voltage by the comparison unit so as to generate a control signal; and sending the control signal to the power supplying device so as to switch between the power supply modes.

Compared with the prior art, the present invention provides a power supply mode switching circuit and method whereby a power supplying device and an electronic product are connected together. The power supplying device has a plurality of power supply modes, such as a pulse-width modulation mode and a burst mode.

An operating current of the electronic product is sampled by the power supply mode switching circuit so as to generate a control signal in real time to change a power supply mode of the power supplying device, enable the power supplying device to supply the operating current required for the operation of the electronic product, and prevent the power supplying device from consuming power excessively for supplying a redundant current. The magnitude of the operating current correlates with the total circuit load inside the electronic product. Depending on the total circuit load, the operating current is further divided into an operating current in a light load mode and an operating current in a heavy load mode.

If a supplying current provided by the power supplying device conforms with the operating current required for the operation of the electronic product, the power of the power supplying device is completely applicable to the electronic product to thereby allow the power supplying device to have a high power conversion efficiency according to the Joule's law P=Î2*R (where P denotes power, I denotes operating current, and R denotes the total circuit load inside the electronic product). Conversely, if the power supplying device supplies a supplying current which is obviously larger than the operating current, then, in this embodiment, the power thus generated obviously exceeds the power actually required for the electronic product, and thus the power conversion efficiency of the power supplying device reduces, thereby causing a waste of energy resources.

### BRIEF DESCRIPTION OF THE DRAWINGS

Objectives, features, and advantages of the present invention are hereunder illustrated with specific embodiments in conjunction with the accompanying drawings, in which:

FIG. 1 is a schematic view of a power supply mode switching circuit according to an embodiment of the present invention;

FIG. 2 is a schematic view of the power supply mode switching circuit according to another embodiment of the present invention; and

FIG. 3 is a schematic view of the process flow of a power supply mode switching method according to an embodiment of the present invention.

### DETAILED DESCRIPTION

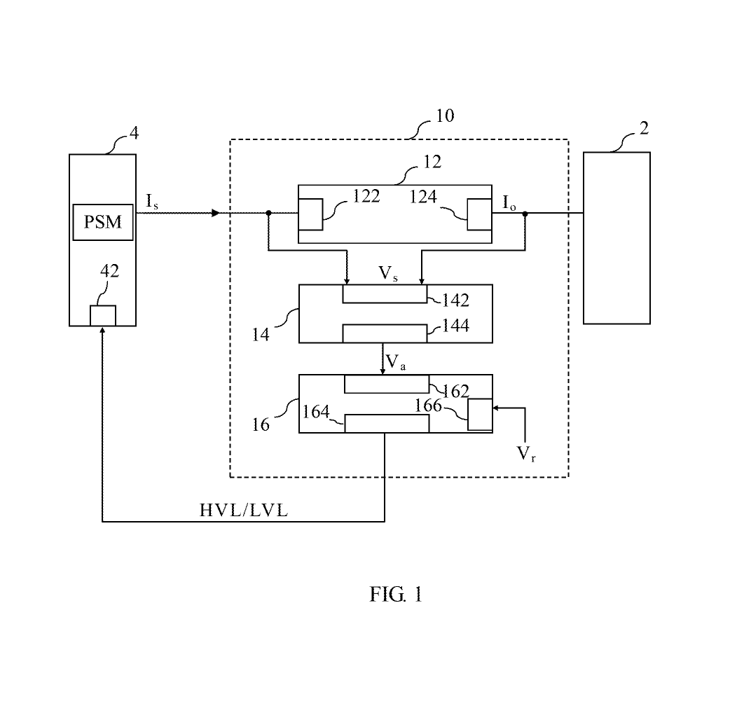

Referring to FIG. 1, there is shown a schematic view of a power supply mode switching circuit according to an embodiment of the present invention. As shown in FIG. 1, the power supply mode switching circuit 10 enables a power supplying device 4 having a plurality of power supply modes PSM to switch between the power supply modes PSM dynamically according to an operating current Iₒ required for an electronic product 2 in operation, so as to output a supplying current Iₛ matching the operating current Iₒ.

The electronic product 2 and the power supplying device 4 are connected in series, and thus the supplying current Iₛ between the electronic product 2 and the power supplying device 4 becomes equal to the operating current Iₒ eventually. If the supplying current Iₛ supplied by the power supplying device 4 is higher than the operating current Iₒ, the surplus portion of the supplying current Iₛ thus supplied goes to ground via the common grounded end of the electronic product 2 and the power supplying device 4. In this embodiment, the power supply modes PSM are exemplified by a pulse-width modulation mode and a burst mode.

Pulse-width modulation (PWM) is a commonly used technique for providing a rectangular pulse wave whose period is a complete ON/OFF cycle. A duty cycle, which is defined as the ratio of the ON time to the period, can be adjusted in order to adjust the period of the supplying current Iₛ supplied at a constant frequency. In general, the pulse-width modulation mode is applicable to a heavy-load environment of the electronic product 2.

Although the burst mode still requires that the supplying current Iₛ is supplied in the form of a pulse wave, the burst mode is different from the pulse-width modulation mode in that the burst mode never outputs the supplying current Iₛ with a specific period and thereby the power supplying device 4 saves power. In practice, the supplying current Iₛ dwindles as soon as it manages to survive after several periods have passed. The attenuation continues until the supplying current Iₛ approximates to the operating current Iₒ. Afterward, the supplying current Iₛ resumes so as to supplement the operating current Iₒ and thereby maintain the operation of the electronic product. In general, the burst mode is applicable to a light-load environment of the electronic product 2.

In this embodiment, the power supplying device 4 has a control pin 42. The control pin 42 switches between the power supply modes PSM according to whether the control pin 42 is operating under a high voltage level HVL (high voltage level) or a low voltage level LVL (low voltage level). For example, if the control pin 42 is operating under a high voltage level HVL, the power supply mode PSM will be the burst mode. For example, if the control pin 42 is operating under a low voltage level LVL, the power supply mode PSM will be the pulse-width modulation mode.

The power supply mode switching circuit 10 comprises a sampling unit 12, an amplifying unit 14, and a comparison unit 16.

The sampling unit 12 has a first input end 122 and a first output end 124. The sampling unit 12 is disposed between the electronic product 2 and the power supplying device 4. The sampling unit 12 is connected to the power supplying device 4 via the first input end 122 and to the electronic product 2 via the first output end 124. The sampling unit 12 is series-connected to the electronic product 2 and the power supplying device 4.

Furthermore, since the sampling unit 12, the electronic product 2, and the power supplying device 4 are connected in series, the supplying current Iₛ supplied by the power supplying device 4 goes through the sampling unit 12 as well. From the perspective of power consumption, with the electronic product 2 being operated with the operating current I°, the sampling unit 12 turns the operating current Iₒ into a sample voltage Vₛ.

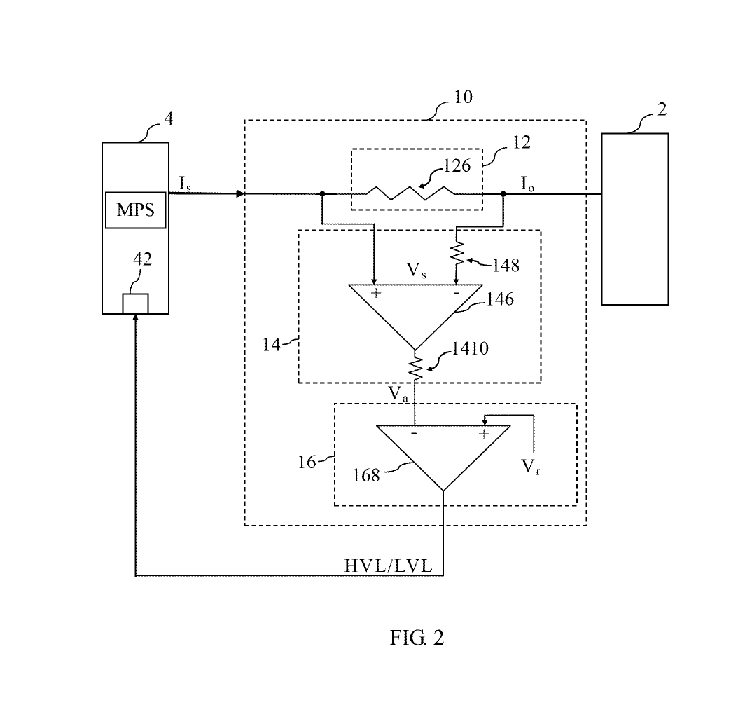

Referring to FIG. 2, in this embodiment, the sampling unit 12 is exemplified by a resistor 126, and thus the sample voltage Vₛ equals the product of the operating current Iₒ and the resistor 126. For example, the resistance of the resistor 126 ranges from 10 milliohms to 20 milliohms and thus is too low to account for a significant portion of the summative resistance of the electronic product 2 and the power supplying device 4.

Referring to FIG. 1 again, the amplifying unit 14 has a second input end 142 and a second output end 144. The two ends of the second input end 142 are connected to the first input end 122 and the first output end 124, respectively, such that the second input end 142 and the sampling unit 12 are connected in parallel. That is to say, the aforesaid parallel connection enables the sample voltage Vₛ to be applied to the amplifying unit 14. Then, the amplifying unit 14 amplifies the sample voltage Vₛ such that the sample voltage Vₛ is turned into the amplified voltage Vₐ, thereby allowing the second output end 124 to output the amplified voltage Vₐ.

The amplifying unit 14 has a voltage amplification ratio between the second input end 142 and the second output end 144.

The purpose of the voltage amplification ratio is to allow the amplified voltage Vₐ, which results from the voltage amplification performed on the sample voltage Vₛ, to be compared with a reference voltage Vᵣ (described below). That is to say, the voltage amplification ratio ensures that the sample voltage Vₛ can undergo voltage amplification in a manner to generate the amplified voltage Vₐ such that the ratio of the amplified voltage Vₐ and the reference voltage Vᵣ is less than a predetermined value. Preferably, the predetermined value is 1000.

Referring to FIG. 2, in this embodiment, to serve an exemplary purpose, the amplifying unit 14 comprises an operational amplifier 146, an input resistance 148, and an output resistance 1410. The voltage amplification ratio of the amplifying unit 14 equals the ratio of the output resistance 148 to the input resistance 1410. That is to say, the voltage amplification ratio of the amplifying unit 14 is calculated by dividing the output resistance 148 by the input resistance 1410.

Referring to FIG. 1, the comparison unit 16 has a third input end 162, a third output end 164, and a reference voltage end 166. The third input end 162 is connected to the second output end 144 and receives the amplified voltage Vₐ. The comparison unit 16 receives a reference voltage Vᵣ through the reference voltage end 166. The comparison unit 16 compares the amplified voltage Vₐ and the reference voltage Vᵣ. The third output end 164 of the comparison unit 16 sends a control signal. The control signal is for use in switching the power supply modes. In this embodiment, for example, the control signal comes in the form of a high voltage level HVL or a low voltage level LVL. Furthermore, the high voltage level HVL or the low voltage level LVL is applied to the control pin 42 of the power supplying device 4 and adapted for the switching of the power supply modes PSM.

Referring to FIG. 2, in this embodiment, the comparison unit 16 is exemplified by a voltage comparing unit 168. The voltage comparing unit 168 has three pins, namely one receiving the reference voltage Vᵣ, another one connected to the second output end 144 to receive the amplified voltage Vₐ, and the other one outputting the result of comparison of the reference voltage Vᵣ and the amplified voltage Vₐ, that is, outputting the high voltage level HVL or the low voltage level LVL. At the high voltage level HVL, the power supplying device 4 switches to the burst mode. At the low voltage level LVL, the power supplying device 4 switches to the pulse-width modulation mode.

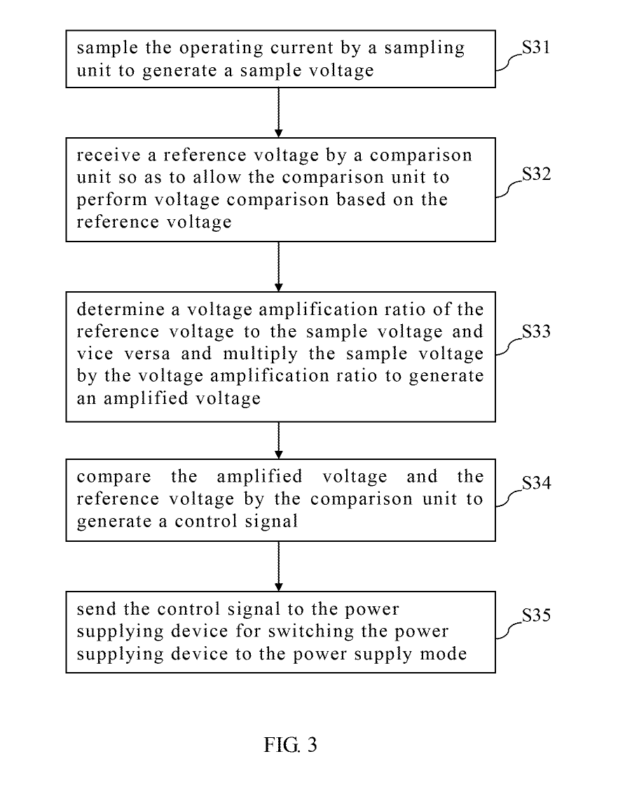

Referring to FIG. 3, there is shown a schematic view of the process flow of a power supply mode switching method according to an embodiment of the present invention. As shown in FIG. 3, the power supply mode switching method is effective in switching between power supply modes (such as a pulse-width modulation mode and a burst mode) of a power supply device dynamically based on an operating current required for an electronic product in operation, so as to output a supplying current matching the operating current.

The process flow of the power supply mode switching method begins with step S31 which involves sampling the operating current by a sampling unit so as to generate a sample voltage. In step S31, the sampling unit is series-connected to the electronic product and the power supplying device. The operating current is retrieved from the sampling unit to measure the sample voltage between the two ends of the sampling unit.

Step S32 involves receiving a reference voltage by a comparison unit so as to allow the comparison unit to perform voltage comparison based on the reference voltage.

In step S33, a voltage amplification ratio of the reference voltage to the sample voltage and vice versa is determined, and the sample voltage is multiplied by the voltage amplification ratio to generate an amplified voltage, such that the amplified voltage can be compared with the reference voltage. The ratio of the amplified voltage and the reference voltage is less than a predetermined value. Preferably, the predetermined value is 1000. In another embodiment, in step S33, the voltage amplification ratio depends on a combination circuit of an operational amplifier, an output resistance, and an input resistance. The operational amplifier determines the voltage amplification ratio by dividing the output resistance by the input resistance. For example, if the sample voltage is expressed in microvolt (μV) and the reference voltage is expressed in millivolt (mV), the output resistance will be 1000 times as large as the input resistance.

In step S34, the comparison unit compares the amplified voltage and the reference voltage so as to generate a control signal.

For example, if the amplified voltage is higher than the reference voltage, the comparison unit will send the control signal in the form of a high voltage level for switching the power supplying device to the burst mode. For example, if the amplified voltage is lower than the reference voltage, the comparison unit will send the control signal in the form of a low voltage level for switching the power supplying device to the pulse-width modulation mode. For example, if the amplified voltage equals the reference voltage, the comparison unit will send the control signal in the form of a high voltage level or a low voltage level so as for the power supplying device to stay at the burst mode or the pulse-width modulation mode.

Step S35 involves sending the control signal to the power supplying device for switching the power supplying device to the power supply mode.

Accordingly, the present invention provides a power supply mode switching circuit and method whereby a power supplying device and an electronic product are connected together in a manner that an operating current of the electronic product is sampled so as to generate a control signal in real time to change a power supply mode of the power supplying device, enable the power supplying device to supply the operating current required for the operation of the electronic product, and prevent the power supplying device from consuming power excessively for supplying a redundant current.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A power supply mode switching circuit for switching between power supply modes of a power supplying device dynamically based on an operating current required for an electronic product in operation, so as to output a supplying current matching the operating current, the power supply mode switching circuit comprising:
a sampling unit having a first input end and a first output end, connected to the electronic product and the power supplying device, respectively, and adapted to convert the supplying current from the power supplying device into a sample voltage;
an amplifying unit parallel-connected to the sampling unit, having a second input end and a second output end, receiving the sample voltage via the second input end to transform the sample voltage into an amplified voltage by voltage amplification, and outputting the amplified voltage via the second output end; and
a comparison unit having a third input end, a third output end, and a reference voltage end, the third input end being connected to the amplifying unit, the reference voltage end receiving a reference voltage, the comparison unit comparing the amplified voltage and the reference voltage and outputting a control signal via the third output end for switching between the power supply modes.

2. The power supply mode switching circuit of claim 1, wherein the sampling unit is a resistor of a resistance ranging from 10 milliohms to 20 milliohms.

3. The power supply mode switching circuit of claim 2, wherein the sample voltage is a product of the supplying current and the resistance.

4. The power supply mode switching circuit of claim 1, wherein the amplifying unit has a voltage amplification ratio equivalent to one between the second output end and the second input end.

5. The power supply mode switching circuit of claim 4, wherein the amplifying unit further comprises an operational amplifier, an input resistance, and an output resistance, the operational amplifier allowing the amplifying unit to have the voltage amplification ratio based on a ratio of the output resistance to the input resistance.

6. The power supply mode switching circuit of claim 1, wherein the power supply modes include a pulse-width modulation mode and a burst mode.

7. The power supply mode switching circuit of claim 6, wherein, if the amplified voltage is higher than the reference voltage, the comparison unit will send the control signal in form of a high voltage level for switching the power supplying device to the burst mode.

8. The power supply mode switching circuit of claim 6, wherein, if the amplified voltage is lower than the reference voltage, the comparison unit will send the control signal in form of a low voltage level for switching the power supplying device to the pulse-width modulation mode.

9. The power supply mode switching circuit of claim 6, wherein, if the amplified voltage equals the reference voltage, the comparison unit will send the control signal in form of a high voltage level or a low voltage level so as for the power supplying device to stay at the burst mode or the pulse-width modulation mode.

10. A power supply mode switching method for switching between power supply modes of a power supply device dynamically based on an operating current required for an electronic product in operation, so as to output a supplying current matching the operating current, the power supply mode switching method comprising the steps of:
sampling the operating current by a sampling unit so as to generate a sample voltage;
receiving a reference voltage by a comparison unit so as to allow the comparison unit to perform voltage comparison based on the reference voltage;
determining a voltage amplification ratio of the reference voltage to the sample voltage and vice versa and multiplying the sample voltage by the voltage amplification ratio to generate an amplified voltage such that a ratio of the amplified voltage and the reference voltage is less than a predetermined value;
comparing the reference voltage and the amplified voltage by the comparison unit so as to generate a control signal; and
sending the control signal to the power supplying device so as to switch between the power supply modes.

11. The power supply mode switching method of claim 10, wherein, in the step of determining a voltage amplification ratio of the reference voltage to the sample voltage and vice versa and multiplying the sample voltage by the voltage amplification ratio to generate an amplified voltage such that a ratio of the amplified voltage and the reference voltage is less than a predetermined value, the voltage amplification ratio depends on a combination circuit of an operational amplifier, an output resistance, and an input resistance, wherein the operational amplifier determines the voltage amplification ratio by dividing the output resistance by the input resistance, wherein the voltage amplification ratio equals a ratio of the output resistance to the input resistance.

12. The power supply mode switching method of claim 11, wherein, if the sample voltage is expressed in microvolt (μV) and the reference voltage is expressed in millivolt (mV), the output resistance will be 1000 times as large as the input resistance.

13. The power supply mode switching method of claim 10, wherein the power supply modes include a burst mode and a pulse-width modulation mode.

14. The power supply mode switching method of claim 13, wherein, if the amplified voltage is higher than the reference voltage, the comparison unit will send the control signal in form of a high voltage level for switching the power supplying device to the burst mode.

15. The power supply mode switching method of claim 13, wherein, if the amplified voltage is lower than the reference voltage, the comparison unit will send the control signal in form of a low voltage level for switching the power supplying device to the pulse-width modulation mode.

16. The power supply mode switching method of claim 13, wherein, if the amplified voltage equals the reference voltage, the comparison unit will send the control signal in form of a high voltage level or a low voltage level so as for the power supplying device to stay at the burst mode or the pulse-width modulation mode.
